(19) United States
(12) Patent Application Publication
(10) Pub. No.: US 2011/0111724 A1
(43) Pub. Date: May 12, 2011

(54) Method and apparatus for combating distracted driving

(76) Inventor: David Baptiste, Haslet, TX (US)

(21) Appl. No.: 12/590,582

(22) Filed: Nov. 10, 2009

(51) Int. Cl. H04M 11/04; H04M 3/00

(52) U.S. Cl. 455/404.1; 455/418; 345/169; 455/466

(57) ABSTRACT

A method and apparatus for combating distracted driving that is the result of using an electronic device in a vehicle inhibits the device or its distracting functions when the device is traveling over walking speed. The system is especially useful in combating distracted driving due to texting.

### FIELD OF THE INVENTION

This invention relates to distractions while operating vehicles and other machinery, and more particularly to a method and apparatus for inhibiting the operation of electronic distracting devices when the sensed speed of the device is above that normally associated with walking.

### BACKGROUND OF THE INVENTION

Distracted driving in the form of texting has received prominence when viewed from research that establishes that texting is at least as problematic as drunken driving. Texting refers to the utilization of a wireless device to transmit and receive texts usually in the form of SMS message units or in the form of short sentences such as tweets involved in Twittering. The problem with the operation of such devices in vehicles or indeed in the operation of heavy equipment which moves at substantial speeds is that the distraction caused in operating such a device takes an individuals glance off the road or other vehicle track while one is either typing in letters into the device or looking at the device in order to ascertain message content.

Not only is texting a problem for which legislation is proposed to fine texting while driving, there are other activities which cause an individual to avert ones gaze. They include for instance, television type displays or game displays which when operated while driving cause one to gaze towards the display. This in turn causes one to not be aware of the road or path ahead for significant lengths of time.

The result is that car crashes and loss of life during texting has become a problem when the individual either cannot keep focused on the road ahead to avoid straying into an opposing lane or fixed object; or to be able to avoid an oncoming vehicle or obstruction.

While the above proposed legislation is a step in the right direction to prevent people from operating such distracting devices, legislation is not particularly effective, especially given the proclivity of individuals who want to communicate via texting during the course of driving.

Not only is texting a distracting activity, also distracting is for instance the playing of video games by the driver, or even the use of two-way communications equipment which distracts the driver from his primary responsibility of guiding a vehicle. Additionally, even being distracted by commercial radio broadcasts has been implicated in vehicle accidents.

There therefore is a need to be able to control the activity of an individual behind the wheel of a car or in control of moving machinery to prohibit the individual in engaging in such activities when the vehicle or piece of equipment is in motion.

While it is true that other distracting activities during driving include eating and talking to passengers, by far the more prevalent accident mode is when one is forced to avert ones eyes to a display in order to participate in the particular activity.

Since legislative means are not particularly effective in eliminating the prohibited activity as seen by the lack of enforcement of hands-free driving in certain jurisdictions, there is an ultimate requirement to be able to control the individual to not participate in distracting activities when operating a vehicle.

### SUMMARY OF THE INVENTION

In order to control the activities in which an individual can participate while behind a wheel or operating other moving vehicles as trains and earth moving equipment, in the subject invention the speed of the electronic devices causing the distraction is sensed, and its operation is inhibited so that it is no longer a distraction. In one case the device is deactivated. This in return removes the distraction from the driver or heavy machine operator so that the operator's attention can be clearly focused on the task at hand, namely driving the vehicle.

In one embodiment for wireless phone use, either the keyboard used for texting or e-mailing can be inhibited when the speed of the device is above walking speed, for instance 3 mph, or the device may be completely disabled when exceeding a threshold speed. Alternatively, the display which displays the text, video game or other activity can be blanked at the time the device is at a speed exceeding walking speed; or various functions of the electronic device can be selectively inhibited. Note for purposes of the subject invention, texting includes e-mailing or in general the transmission of alphanumeric characters.

For instance if it is desirable to inhibit the keyboard and display of a wireless device when the speed threshold has been exceeded, it may nonetheless be important to be able to text 911 in the case of an emergency. Thus the inhibiting function can be disabled for various cases such as in the case of an emergency.

Likewise if it is deemed important to inhibit cell phone activity in general, the cell phone itself may be inhibited when the speed threshold has been exceeded, thus to preclude verbal communications using the cell phone.

The same is true for other electronic devices such as for instance computers exhibiting graphics on a display, or for two-way radios which can involve a distraction to the driver.

In one embodiment of the subject invention the speed sensing and device inhibiting apparatus can be carried by the device located within the vehicle, be it a handheld device or a built in device, with the speed sensing in one embodiment being through the utilization of GPS signals which arrive at a vehicle-carried GPS receiver or device-carried GPS receiver.

There is also another method of determining vehicle speed and that is through the triangulation afforded by time difference of arrival or angle of arrival systems in which signals from the transceiver at the vehicle are processed by a number of different cell towers on a wireless network. Triangulation is then used to determine the position of the vehicle and the speed of the vehicle.

In these situations a wireless network carrier can determine for instance the speed of the vehicle through the triangulation method mentioned above and send signals to the transceiver to disable selected functions of the transceiver, for instance texting and/or display.

In some GPS systems, called assisted GPS systems, the position of the vehicle is calculated at the network, with the GPS signals being received by a transceiver having the GPS antenna, with the final velocity solution being performed at the network with which the transceiver is communicating.

Thus it is possible to inhibit the operation of the distracting device either by providing the distracting device with a GPS receiver and inhibiting the operation in response to detected speeds above a predetermined threshold, or the device can be disabled or inhibited remotely through the unitization of the signals from a wireless network to disable the distracting functions of the device or the device itself.

A third way of obtaining velocity of the device is to be able to detect vehicle speed directly from instruments at the vehicle. For instance, it is possible to have an optical reading device that looks at the speedometer of the vehicle and determines vehicle speed through that type of readout.

Also with many vehicles, the speed of the vehicle detected by whatever means, is available on the vehicle bus such that the distracting device can be inhibited by vehicle generated indications of velocity.

Additionally, speed can be deduced from accelerometers either in the vehicle or the device.

The inhibiting mechanism can be in the form of a module on a particular electronic device, or a module activated by a wireless carrier.

For those electronic devices having displays, when the inhibiting function is activated, it may be desirable to place an indication on the display that such inhibiting will or has occurred. This can be in the form of an audible alarm signal or an alarm display to indicate to the driver of the vehicle that he or she is exceeding walking speed. Thus whether the alarm is visual or audible, the individual operating the vehicle can be alerted to the fact that the vehicle speed has exceeded the walking speed and that whatever device the individual is using is no longer usable, thereby persuading the individual not to avert his or her gaze to look at or use such a device.

There are however certain instances where a person seeking to use such an electronic device is for instance on a train or on a boat and is not in control of guiding or operating the train or boat. Since the position of the individual and thus his or her device can be ascertained using a GPS or triangulation methodology, it is possible to provide an exclusion zone, for instance along the right-away of the railway, or for instance over water to permit the individual to use the device, since whether or not the individual is distracted does not cause a safety issue.

It is also possible to be able to program the inhibiting device to permit certain allowed activities, such as for instance the dialing of 911 in an emergency and to verbally communicate using the wireless phone or PDA.

The subject system and method applies to not only cars and lightweight vehicles but also to interstate trucking companies which are seeking to provide an improved safety record for their trucks. Even though transportation companies may seek to communicate with their trucks for dispatch purposes, and may wish to know the location of their trucks, these functions can be accomplished automatically without having the individual direct ones eyes to the display, thus eliminating distractions.

Alternatively, when a fleet management company wishes to communicate with its drivers or have the drivers communicate with them, the subject system will permit the communication but only when the vehicle is at or below walking speed.

For purposes of the subject invention, walking speed is in general up to about 3 mph. Thus the threshold set in the subject invention may be set to inhibit device operation above 3 mph speeds.

Since distracted driving is the preeminent cause of accidents, in the subject invention it is the purpose of the anti-distraction system to detect vehicle speed and to inhibit the operation of any electronic device which could cause distraction, be it a cell phone with texting capabilities, a two-way radio, a vehicle radio, or a computer generated display, all of which can distract a driver.

### BRIEF DESCRIPTION OF THE DRAWINGS

These and other features of the subject invention will be better understood in conjunction with the Detailed Description in connection with the Drawings of which:

FIGS. 1A, 1B and 1C are diagrammatic illustrations of a driver texting in the face of an oncoming truck in which the drivers gaze is directed to the texting display, thus distracting the driver from the oncoming danger;

FIG. 2 is a diagrammatic illustration of the utilization of a wireless device having a texting inhibit module actuated when a velocity threshold set to normal walking speed is exceeded due to the sensing of speed via a GPS receiver;

FIG. 3 is a block diagram illustrating the sensing of speed using a GPS device, triangulation, or accelerometers to determine speed, with a speed threshold being set at or above 3 mph to disable the texting capability of the wireless device in FIG. 2;

FIG. 4 is a diagrammatic illustration of the utilization of a texting inhibit device within a wireless phone to alert the user that the user is proceeding at an unsafe speed to text, with signals transmittable from the device to indicate that the driver is driving an cannot text at the moment;

FIG. 5 is a diagrammatic illustration of the utilization of exclusion zones to defeat text inhibiting when the individual traveling above the speed threshold is within the exclusion zone;

FIG. 6 is a block diagram illustrating the inhibiting of a distracting device when the speed of the device is above a threshold;

FIG. 7 is a diagrammatic illustration of the inhibiting of the keyboard of a wireless phone, except for dialing of 911, and the display of an alarm when the detected speed is above a predetermined threshold;

FIG. 8 is a diagrammatic illustration of a wireless phone in which its display is inhibited when the detected speed is above a predetermined threshold, also displaying an alarm indication at the phone;

FIG. 9 is a diagrammatic illustration of a wireless phone in which receipt of data is inhibited when the speed of the device is above a predetermined threshold, also displaying an alarm condition;

FIG. 10 is a diagrammatic illustration of a wireless phone in which transmissions from the wireless phone are inhibited when the speed of the wireless phone exceeds a predetermined threshold, with the display of an alarm condition being included;

FIG. 11 is a diagrammatic illustration of the utilization of a wireless network to determine speed of a wireless phone and to send signals through the wireless network to control the wireless phone or handheld device to provide the inhibiting function;

FIG. 12 is a diagrammatic illustration of the utilization of the velocity of a vehicle available from a vehicle, either utilizing an optical head to read a speedometer or utilizing a vehicle interface, in which velocity is determined not through GPS and triangulation, but rather through vehicle mounted speedometers or other apparatus; and,

FIG. 13 is a diagrammatic illustration of the designated driver's exception to the inhibiting of passenger's electronic devices.

### DETAILED DESCRIPTION

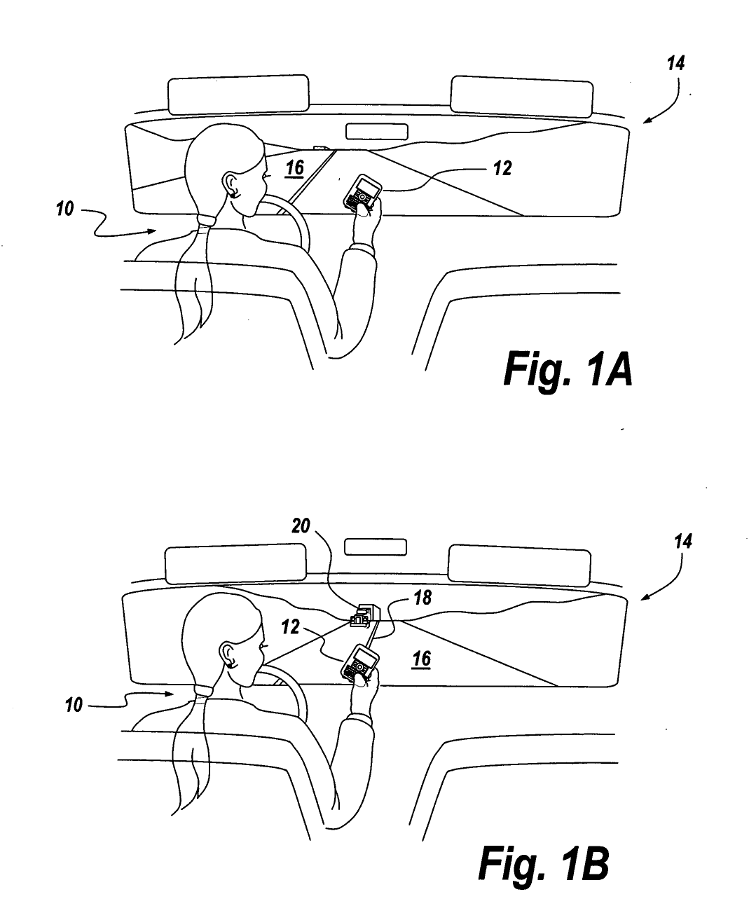

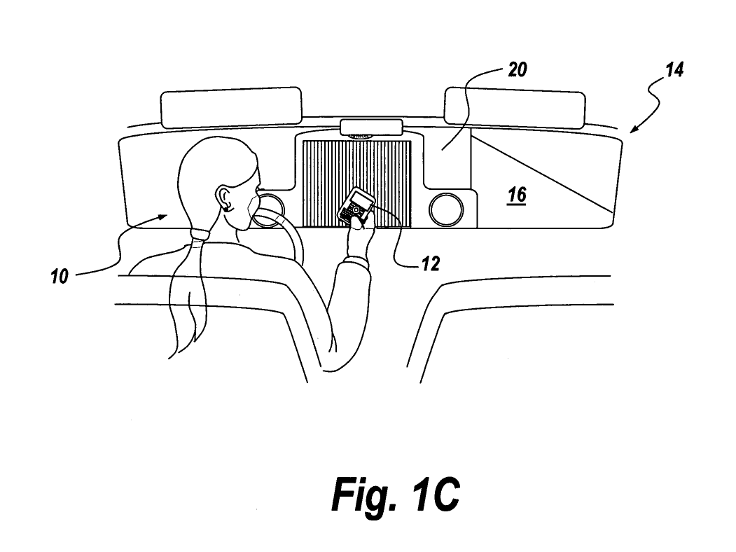

Referring now to FIG. 1A, an individual 10 may be texting on a wireless device 12 in which the individual is within a vehicle 14 that is driving along a highway 16 in the appropriate lane thereof.

FIG. 1B shows the individual 10 distracted to the point that vehicle 14 is wandering over centerline 18 of road 16, due to the distraction caused by glancing at the wireless device 12. Also shown is a truck 20 traveling along road 16 in an opposite direction for which a collision is eminent if the operator does not take evasive action.

Referring to 1C, individual 10 is so distracted that truck 20 is directly upon vehicle 14, showing that within seconds of distraction a crash is eminent.

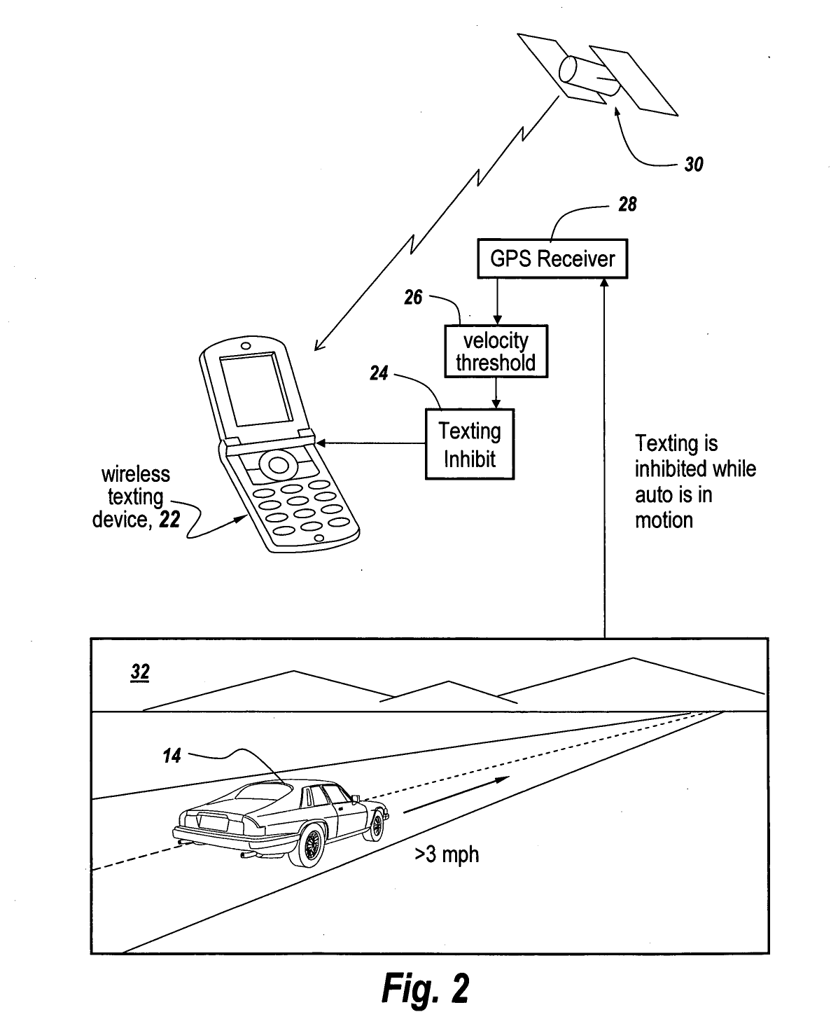

Referring to FIG. 2, in one embodiment of the subject invention a wireless texting device 22 has its texting inhibited via a texting inhibit module 24 which is activated through a velocity threshold module 26 coupled to a GPS receiver 28 which senses the velocity of the vehicle and thus the cell phone which is carried by the individual.

The GPS receiver receives GPS signals from a number of GPS satellites 30, of which one is pictured.

The threshold velocity which activates text inhibiting is shown at 32 where a vehicle 14 is detected going above 3 mph, with 3 mph corresponding to the normal maximum walking speed of an individual.

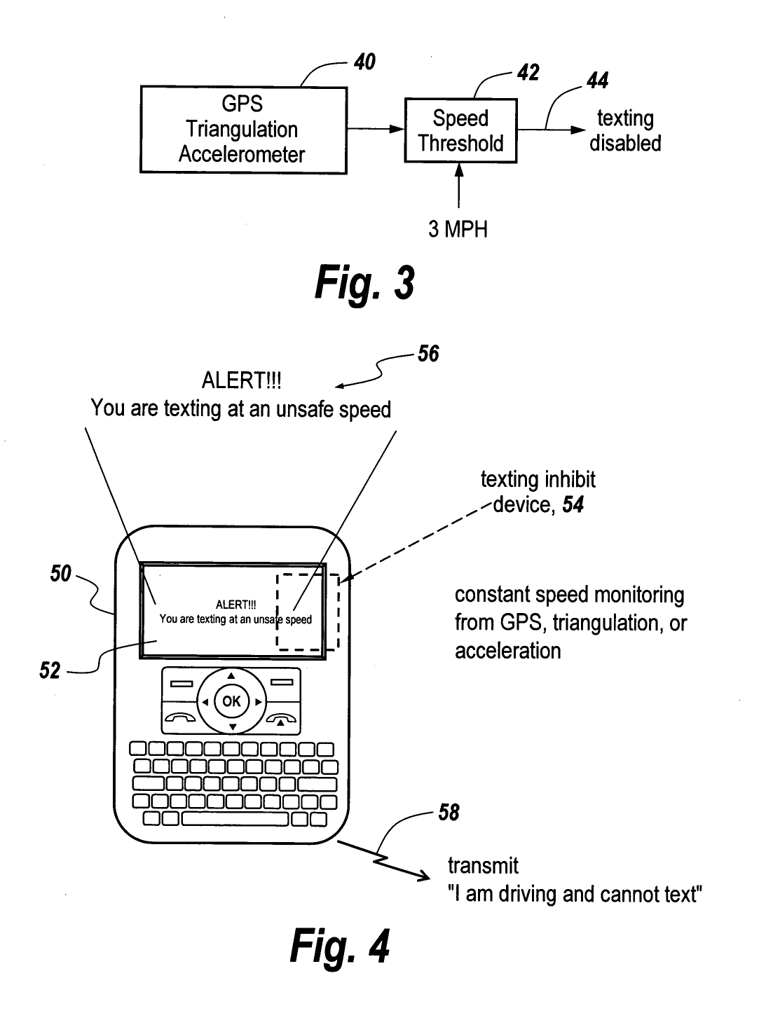

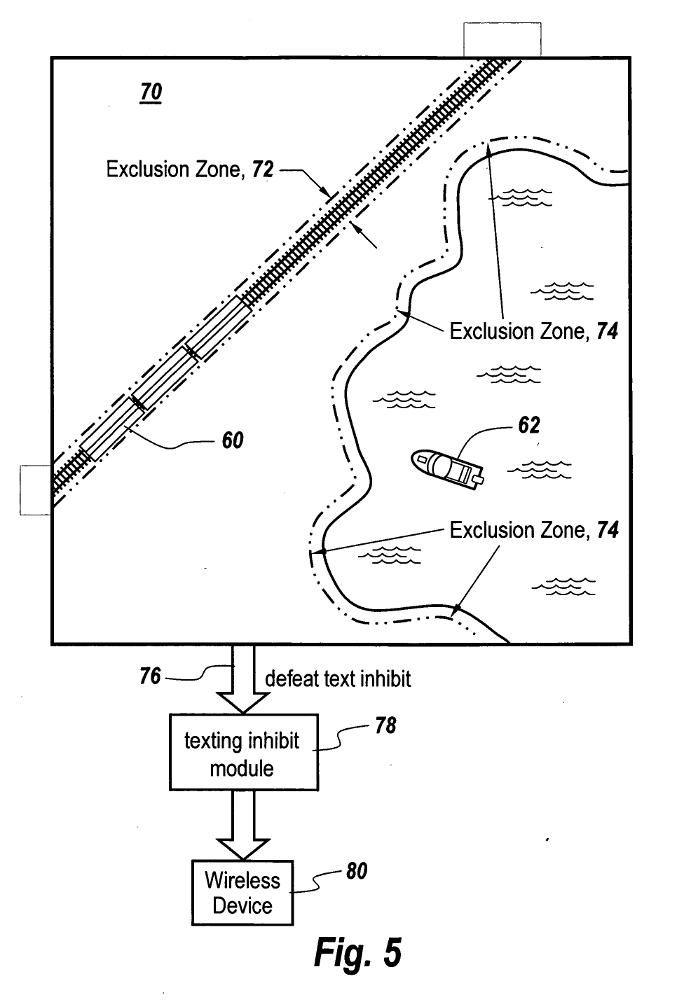

Referring to FIG. 3, in this embodiment either GPS, triangulation or accelerometers shown at 40 are utilized to develop a speed indication, with speed threshold 42 being set at 3 mph to send out a signal over line 44 to disable the texting function of the appropriate wireless device.

Referring to FIG. 4, a wireless device 50 includes a display 52 and has internal text inhibiting device 54 which is coupled to a constant speed monitoring system provided by an on-board GPS in one embodiment, or by triangulation between cell towers or by accelerometers used to sense speed.

In the case that the device is traveling at a speed above the texting inhibit threshold, an alert 56 is displayed on screen 52 to indicate that the person is texting at an unsafe speed. Also in one embodiment, a transmitted signal that “I am driving and cannot text” is transmitted as illustrated at 58 from wireless phone or PDA 50 to whomever the device is communicating with.

In the case where an individual is on a public conveyance, such as a train 60 or a boat 62, and if the device carried includes a position determining element, one can correlate the position of the vehicle in terms of a map 70 which has exclusion zones 72 and 74, respectively around a train right-away or bounding a body of water. It is the purpose of providing exclusion zones to enable the individual to operate the distracting device by defeating text inhibiting as indicated by arrow 76 which defeats the text inhibiting module 78 that is coupled to device 80.

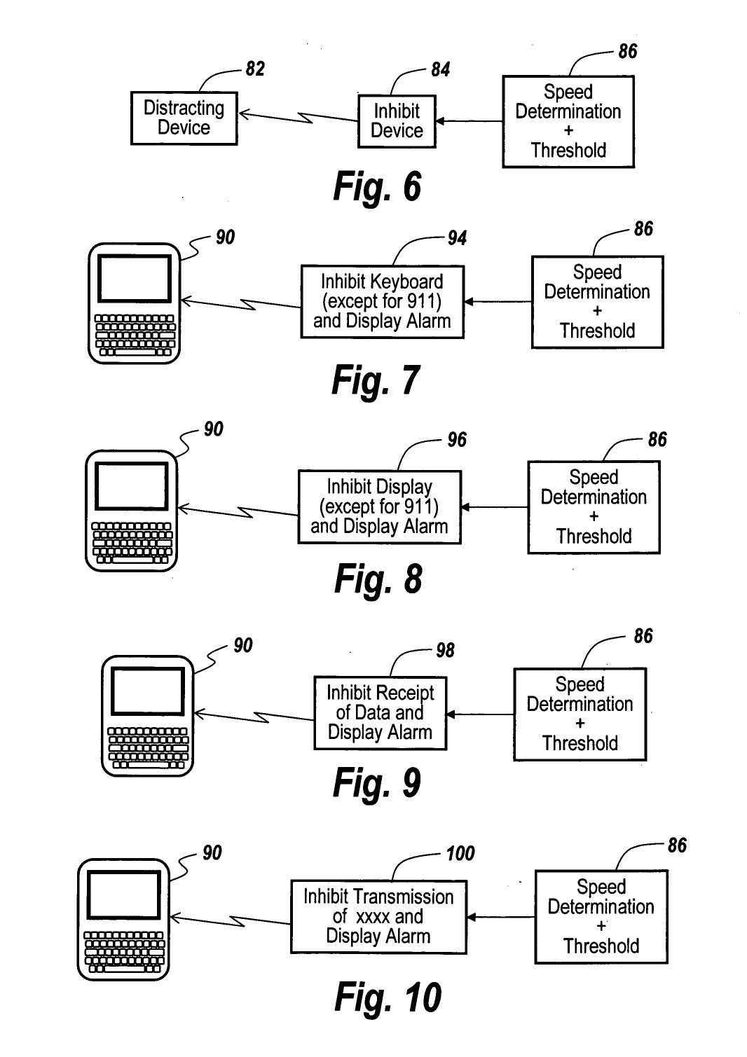

While the subject invention has heretofore been described in terms of distractions caused by texting, it will be appreciated that a number of different types of distractions can be problematic from any one of a number of different electronic devices. Not only are cell phones or PDAs with displays the culprits in the distraction war, the distracting device 82 in FIG. 6 may also be a computer, the display on a radio or a gaming toy such as a Gameboy. Moreover, the distracting device may be as simple as a TV monitor if one is trying to look at TV either for commercially generated TV shows or for viewing movies.

Regardless of the type of distracting device, an inhibiting device 84 is provided coupled to a speed detector and threshold unit 86 which can inhibit the electronic device in a number of different ways to render the device unattractive for use.

Referring to FIG. 7, in the case of a wireless phone 90, this device has a keyboard 92 which can be inhibited by inhibit keyboard module 94 which is responsible for inhibiting the effect of pushing the keyboard keys, with the exception of entering an emergency number such as 911.

The inhibit keyboard module also includes a module for displaying an alarm condition to indicate that inhibiting is about to occur or has occurred.

The speed detection and threshold unit 86 of FIG. 6 is used to provide an input to inhibiting device 94.

Referring to FIG. 8, wireless phone 90 may have its display inhibited by a display inhibit module 96, with the display nonetheless displaying in one embodiment that an alarm condition has occurred meaning that the inhibiting is or is about to occur. Likewise the speed detection and thresholding unit 86 is coupled to inhibit module 96.

Referring to FIG. 9, wireless phone 90 is inhibited in terms of the receipt of signals by inhibit receipt device 98 so that the receipt of data is inhibited, thereby making the wireless phone useless for the receipt of such data. It is important to note that if it is desirable to be able to have the person utilize the wireless device for verbal transmissions, the inhibiting of the receipt of data does not preclude this function. By inhibiting of the receipt of data which is displayed on the display of the wireless phone, it eliminates the tendency to glance over at the wireless device for ascertaining the data. Here again speed detector and threshold unit 86 is employed and is coupled to inhibit unit 98.

Referring to FIG. 10, wireless phone 90 may be inhibited as shown at 100 from transmitting any information whether it be text, voice or otherwise, thereby rendering its operation useless, whereby the driver will cease using the device. Again speed detection and threshold unit 86 is coupled to inhibit module 100.

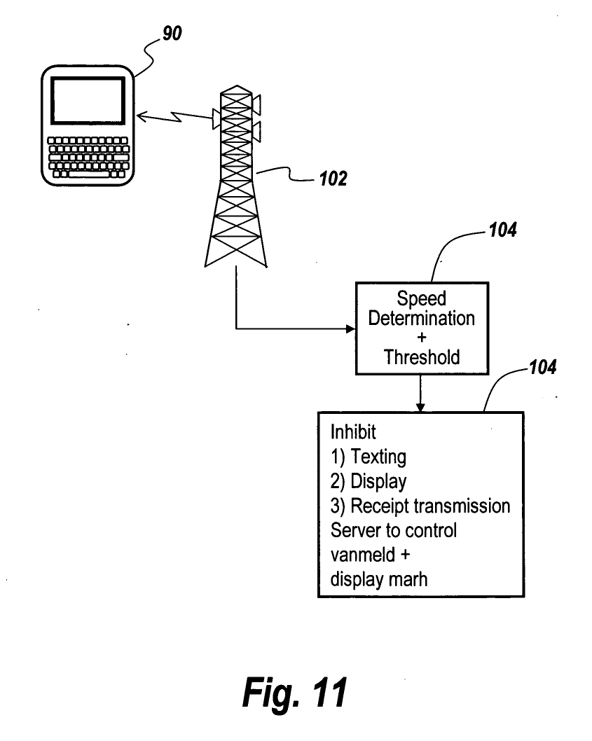

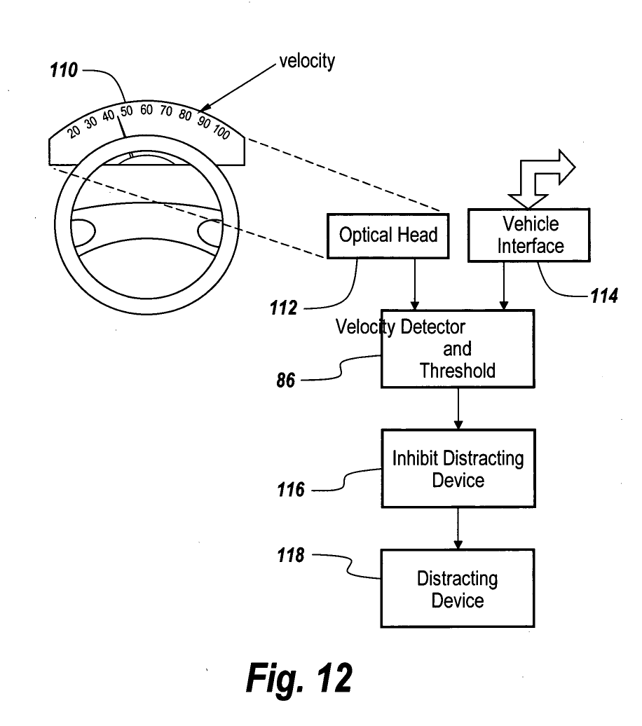

With respect to FIG. 11, wireless phone 90 may be provided with either an assisted GPS receiver or may have its position and therefore speed, determined at a cell site 102 such that the speed of the vehicle and thus the wireless device is determined at the wireless network as illustrated at 104. Here the thresholding functions are provided from the wireless network. The wireless network in turn upon sensing speeds above a predetermined threshold activates an inhibit function 104 which through signals back through the wireless network and to the wireless phone inhibits either texting, display, receiving/transmission or other distracting operation of the wireless device.

In all of the embodiments shown in FIGS. 7-11, there is a display of the impending inhibit or actual inhibit of the device.

Referring to FIG. 12, the speed of a vehicle may be determined by a speedometer 110 or for instance by accelerometers within the vehicle such that the speed of the vehicle is available from the vehicle itself. In these types of situations neither a GPS nor a wireless connection is necessary in order to actuate the inhibiting module. In one embodiment an optical head 112 physically views the speedometer, determines the speed and provides the speed to the velocity detection and threshold unit 86, whereas a vehicle interface 114 may be connected to the vehicle bus, assuming that the speed of the vehicle is available on the vehicle bus, with the vehicle interface coupled to the speed detector and thresholding unit 86.

In summary, a velocity detection and thresholding device is coupled to a distracting device inhibiting module which is in turn coupled to a distracting device to inhibit the distracting functions of the device.

### Designated Driver

While the subject invention has been described as a system for preventing distractions, especially with respect to cell phones and texting, it may be desirable to provide an electronic exception that takes into account the selection of a designated driver who will not use his wireless device.

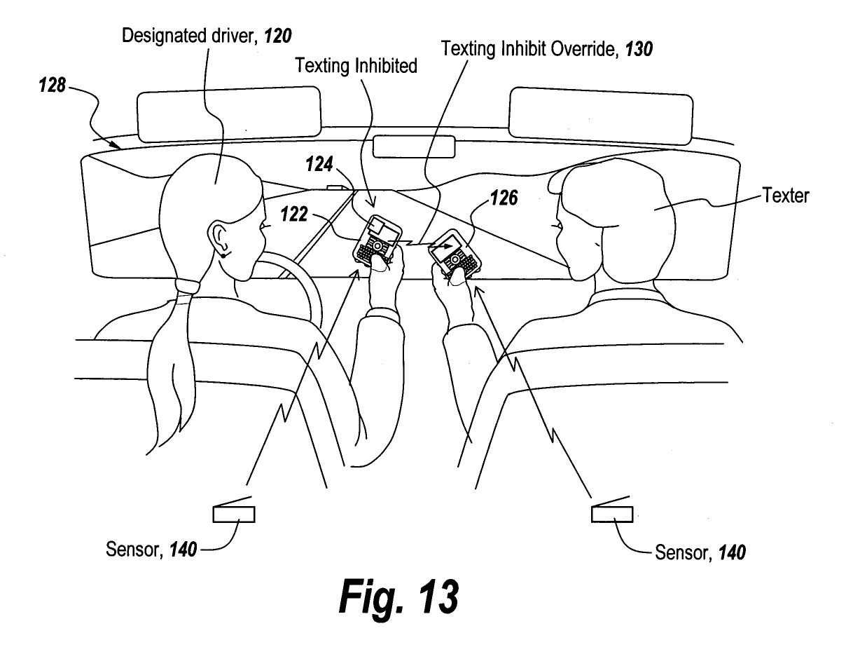

Referring to FIG. 13, for instance if a designated driver 120 is appointed who commits not to text or use his cell phone 122, then others in the car will be permitted to text. This agreement can be effectuated through the pressing of a designated driver button 124 which communicates with other wireless devices 126 within the car or vehicle 128 that disables or overrides the inhibit function for these devices. This communication between the wireless phone of the designated driver and the other electronic devices in the car may be accomplished with a BlueTooth or an infrared link 130. The range of the BlueTooth or infrared link is made such that its range is limited to prevent disabling inhibit circuits for wireless devices carried in nearby vehicles.

Moreover, in order to establish that one is a designated driver one may have to input the number of passengers in the vehicle for authentication purposes.

Presence detecting apparatus such as in-seat sensors 140 may be used to confirm the number of passengers so that if the driver is acting solo and seeks to disable the inhibiting of a device within a second phone he is carrying, the disable codes normally sent via BlueTooth or infrared will be overridden. Thus an individual cannot simply place another wireless device he wishes to use beside him in the car or vehicle. Sensors 140 can be any one of a number of proximity sensors that can be integrated into vehicle key-forbs, vehicle steering wheels, arm rests, headliners, doors, seats or floors.

Moreover, if a proximity sensor measures the distance from the vehicle steering wheels to the individual setting off the proximity sensor, if the driver does not have a mobile device, assuming the driver is a sufficient distance away from the steering wheel, the passenger may be permitted to text. This is done by overwriting the inhibiting circuit of the passenger's wireless device if the sensed distance is greater than a predetermined threshold.

Of course, if there is verification that there are no other persons in the car, the designated driver's wireless device may be programmed to provide annoying prompts to dissuade a driver from indicating that he is a designated driver when he is not.

Likewise, if the inhibit function is the province of the wireless carrier, appropriate programs can be provided so that in the absence of BlueTooth or infrared communication between wireless devices indicating the presence of a designated driver, all moving wireless devices in the car will stay inhibited.

### Incoming Texting

If there is an incoming text to an inhibited wireless device, the inhibited wireless device may nonetheless be programmed to send out a message that says “I am traveling and cannot respond”. Moreover, if a designated driver has been designated the inhibited unit may be programmed to send a message that he is a designated driver and that he will respond when he is not in motion.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. Apparatus for the control of texting on a wireless device carried in a moving vehicle, comprising:
a unit within the wireless device for ascertaining the velocity of the unit and thus the velocity of the vehicle; and,
a module for inhibiting a texting function of said wireless device when the speed of the said wireless device is above walking speed.

2. The apparatus of claim 1, wherein said walking speed is above 3 mph.

3. The apparatus of claim 1, wherein said texting function of said module is configured to prevent the transmission of text from said wireless device.

4. The apparatus of claim 1, wherein said wireless device includes a keyboard and wherein said texting function of said module includes inhibiting said keyboard.

5. The apparatus of claim 4, wherein said module does not inhibit the entering of an emergency number, whereby regardless of the speed of said wireless device, said emergency number can be transmitted.

6. The apparatus of claim 1, wherein said wireless device includes a display and wherein said module inhibits the display of alphanumeric characters entered at said wireless device on said display, thereby to provide an indication to the user of said wireless device that a function of said wireless device has been inhibited.

7. The apparatus of claim 1, wherein the inhibiting function of said module includes inhibiting the display of incoming messages.

8. The apparatus of claim 1, wherein the inhibiting function of said module includes inhibiting the transmission of messages from said wireless device.

9. The apparatus of claim 1, wherein the inhibiting function of said module is deactivated when said wireless device is within a predetermined geographic exclusion zone.

10. The apparatus of claim 9, wherein said predetermined exclusion zone extends around a railway right-of-way.

11. The apparatus of claim 9, wherein said predetermined exclusion zone corresponds to a body of water.

12. The apparatus of claim 1, wherein said module includes means at a wireless carrier for determining the position of said wireless device and the speed thereof and wherein the inhibiting function of said module includes signals transmitted from said wireless network to said wireless device to effectuate inhibiting said wireless device when the speed thereof is above walking speed.

13. The apparatus of claim 1, wherein said wireless device includes a communications module for communicating with a second wireless device within said vehicle, said communications module providing a signal to said second wireless communication device to deactivate the inhibiting of said second wireless device responsive to said second wireless device exceeding walking speed, whereby passengers within said vehicle may be permitted to text, whereas the driver of said vehicle has the texting capability of his wireless device inhibited.

14. The apparatus of claim 1, and further including a sensor at each of said wireless devices for determining when a wireless device is within a predetermined distance of the steering wheel of said vehicle, and further including an inhibit override unit for overriding the inhibit function of said module when the sensed position of said device is sufficiently far removed from the steering wheel, whereby any wireless device not within a predetermined distance from the steering wheel is permitted texting functionality.

15. The apparatus of claim 1, wherein the speed of said wireless device is determined by speed sensors within said vehicle.

16. The apparatus of claim 15, wherein the sensed speed of said vehicle is transmitted to said wireless device.

17. The apparatus of claim 1, wherein said velocity sensing unit includes a GPS receiver.

18. The apparatus of claim 1, wherein said velocity sensing unit includes a receiver for receiving signals from a wireless carrier representing the speed of said wireless device.

19. The apparatus of claim 18, wherein said signals from said carrier are derived through triangulation.

20. The apparatus of claim 19, wherein said triangulation utilizes one of time difference of arrival, angle of arrival or combinations thereof.

21. The apparatus of claim 1, wherein said wireless device includes a display and a drive for said display, said driver causing said display to indicate when the texting function of said wireless device is inhibited.

22. The apparatus of claim 1, and further including a unit within said wireless device for transmitting a message from said wireless device indicating that said wireless device has its texting function inhibited.

23. An apparatus for eliminating distractions of a driver of a vehicle when using an electronic device within said vehicle, comprising:
a unit for inhibiting the operation of said electronic device if above walking speed.

24. The apparatus of claim 23, wherein said electronic device includes a display, the activation of which causes distraction of the driver of said vehicle, and wherein the inhibiting of the operation of said electronic device prevents the display of further information on said display.
